(19) United States
(12) Patent Application Publication
(10) Pub. No.: US 2013/0311859 A1
(43) Pub. Date: Nov. 21, 2013

(54) SYSTEM AND METHOD FOR ENABLING EXECUTION OF VIDEO FILES BY READERS OF ELECTRONIC PUBLICATIONS

(71) Applicant: barnesandnoble.com llc, New York, NY (US)

(72) Inventor: Manish MAHAJAN, San Jose, CA (US)

(21) Appl. No.: 13/896,133

(22) Filed: May 16, 2013

Related U.S. Application Data
(60) Provisional application No. 61/649,024, filed on May 18, 2012.

(51) Int. Cl. G06F 17/30

(52) U.S. Cl. CPC G06F 17/30781
USPC 715/203

(57) ABSTRACT

A system and method for executing digital publications having video files embedded therein. In one embodiment all of the video segments in the electronic publication shares the same video characteristics, e.g., the video codec used to encode to video, the video codec profile used, the encoded resolution, and the encoded hit rate. When the first video in the electronic publication is encountered, the system instantiates a decoder node in memory. The decoder node is not released until the execution of the last video in the electronic publication. In an alternative embodiment of the present invention, the various videos embedded in the document do not all share the same video characteristics. In this embodiment, the present invention creates a “map” of the video content describing the location, e.g., page, and the type of video, i.e., the characteristics. The device can then use the map to identify adjacent videos which share the same characteristics and obviate the need of setup and release of socket nodes for similar videos.

### FIELD OF THE INVENTION

The present invention generally relates to reading digital publications, and more particularly to systems and methods for enabling electronic devices to execute video files that are imbedding in or linked to by digital publications.

### BACKGROUND OF THE INVENTION

The effective organization, management and execution of video content embedded in textual content is clearly more difficult than that of text-based content alone. Digital video content is not comprised of written language but is comprised of a sequence of computer codes and data, that are used by a computer-based system to display a video sequence on the display device.

A video codec is a device or software that enables compression or decompression of digital video. Historically, video was stored as an analog signal on magnetic tape. Around the time when the compact disc entered the market as a digital-format replacement for analog audio, it became feasible to also begin storing and using video in digital form, and a variety of such technologies began to emerge.

There is a complex balance between the video quality, the quantity of the data needed to represent it (also known as the bit rate), the complexity of the encoding and decoding algorithms, robustness to data losses and errors, ease of editing, random access, the state of the art of compression algorithm design, end-to-end delay, and a number of other factors.

Video codec designs are often standardized or will be in the future—i.e., specified precisely in a published document. However, only the decoding process needs to be standardized to enable interoperability. The encoding process is typically not specified at all in a standard, and implementers are free to design their encoder however they want, as long as the video can be decoded in the specified manner. Metadata has been employed to address this issue. Metadata are descriptive fields of information that describe the encoding and other characteristics of the video content.

### SUMMARY OF THE INVENTION

The present invention operates in connection with an electronic device for reading digital publication, such as electronic books, eBooks, or electronic magazines or newspapers. Present and future generation digital publications have, and will continue to have video files embedded in the publication itself, or linked in the publication to a server that stores the video files. The present invention enables the electronic device to rapidly execute the video by preloading the media player components prior to the actual execution of the video,

In one embodiment of the present invention, all of the video in the electronic publication shares the same video characteristics, e.g., the video codec used to encode to video, the video codec profile used, the encoded resolution, and the encoded bit rate. The metadata or header of the electronic document contains the video characteristics. The device executing the electronic publication, e.g., an eReader, reads the metadata or header of the electronic document and thus knows that all of the video content in the document can be decoded using the same decoder node (socket node). When the first video in the electronic publication is encountered, the system instantiates the decoder node in memory. However, unlike the prior art, when the video is finished playing, the system of the present invention does not release (unload) the decoder node from memory, but rather retains it for use by the next video in the electronic publication. Thus, using the present invention, the device is able to significantly reduce the amount of time required for set-up and release of the decoder nodes associated with embedded video content in electronic publications.

In an alternative embodiment of the present invention, the various videos embedded in the document do not all share the same video characteristics. In this embodiment, the present invention creates a “map” of the video content describing the location, e.g., page, and the type of video, i.e., the characteristics. The device can then use the map to identify adjacent videos which share the same characteristics. When the first of the adjacent videos is completed, the device know that does not have to release the decoder node in memory, as it can be used by the next video. The decoder node is only released after the last in the series of adjacent videos has finished execution.

In a further embodiment of the present invention, the video to be executed is not embedded in the electronic publication, but is rather stored at a remote location and linked in the document, For this type of electronic publication the system and method of the present invention can use the page-video map as described above to pre-download videos just in time, when the user is approaching a page with that video. Further a low quality version of the video can be embedded in the electronic publication locally and when the user starts playing the video, download the high quality version and switch dynamically. Either of these approaches allow the system to determine the type of videos that are to be played and thus their coding characteristics. A system using the techniques of the present invention will be able to identify adjacent videos that share the same video characteristics and thus be able to maintain the socket nodes in memory and reduce the setup and release times associated with these videos.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates a first embodiment of the present invention in which all videos in an electronic publication have the same coding parameters;

FIG. 2 depicts an exemplary process according to the present invention;

FIG. 3 illustrates an exemplary system according to the present invention; and

FIG. 4 illustrates the components of an exemplary device.

### DETAILED DESCRIPTION OF THE INVENTION

Video electronic publications, or any digital publication, e.g., an electronic magazine, with video content is expected to increasingly become a significant portion of the content available for use by electronic readers.

For a superior experience when viewing an electronic publication it is preferable to have an extremely low media, player setup time, so that when a user navigates to a page with video content on it, the video starts playing automatically, if the author has so desired, with minimum latency. Further, the release time from the media player should be minimal in order to reduce latency for the reader application to display contents for subsequent pages in the electronic publication.

Modern tablets, smart phones and other electronic devices used for reading digital publications typically use integrated chip solutions from various vendors that provide multimedia and video playback capabilities. The way a normal video decoding session typically happens is that a dedicated processor, e.g., a Digital Signal Processor, DSP, is responsible for running the CPU and memory intensive process of decoding a video file and returning frames that the client processor then renders using a display pipeline. Each time a video is requested to be played back, the stack instantiates a DSP module in memory, called a decoder node or a socket node. This is known as the setup. The decoder or socket node is specific to the requested characteristics of the video to be played back, e.g., its resolution, codec and profile. Once the video playback is done, this decoder node is then released.

It has been determined experimentally that a significant amount of time, up to 200 ms, is spent to load a. DSP decoder node for a request to play a video. If a DSP decoder node can be kept alive in memory, the system and the process can save up to 200 ins for each subsequent video playback requests from within an electronic publication. This however, requires that the subsequent video has exactly the same parameters as the first one, i.e., the same codec, profile, profile number, encoded resolution and bit rate. If any of those parameters are different, the loaded DSP decoder node cannot be re-used for a subsequent request and must be unloaded and re-loaded with a new configuration to support the new video.

In a preferred embodiment, authors and publishers of content that has video embedded therein are required to have uniformly coded video content inside a single electronic publication. This uniformity in the parameters of the embedded video content allows the system to retain the same DSP decoder node in memory, thus minimizing the setup and release times for the video player. Such a uniformity of video content is more likely in an electronic book embodiment, where there is typically a single, or very few, author(s) with creative control. In an alternative, and more typical embodiment, videos with different coding parameters are included in a single electronic publication. A typical embodiment with multiple video segments with divergent coding parameters would be an electronic newspapers or magazines. Typically, these types of publication employ video content from multiple sources and it difficult, if not impossible to enforce the requirement of uniformity of video coding, particularly on the tight time schedule that these periodical face for publication.

In the embodiment of the present invention in which all videos in an electronic publication have the same coding parameters, publishers and authors a have a uniform video coding across a single electronic publication. All coding parameters should be same for all the videos embedded in a particular electronic publication. These parameters include:

the video codec used to encode the video;

the video codec profile used;

the encoded resolution; and

the encoded bit rate.

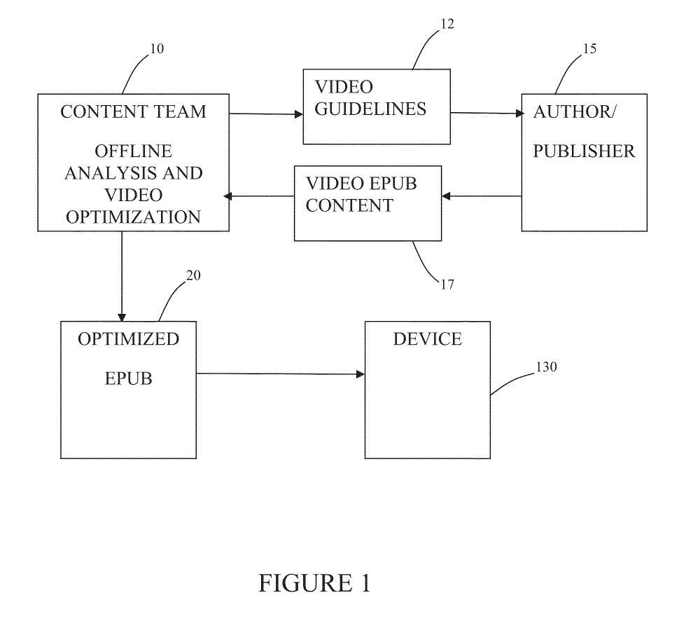

FIG. 1 illustrates an embodiment of the present invention. As illustrated in

FIG. 1, the Content Team 10 informs the publisher of the guidelines 12 for the inclusion of video content in an electronic publication, ePub, content 17. As described above, the guidelines includes at least the preferred video codec used to encode to video, the video codec profile to use, the resolution for encoding and the bit rate to use for encoding.

If the publisher/author 15 agrees to go this route, the metadata information contained in the electronic publication content 12 is updated to include this information, or it can be dynamically fetched. Alternatively, a flag can be set in the electronic publication's header or metadata information saying that the video setup time feature is to be enabled. The content team 10 can either do this for each electronic publication containing video submitted in a manual way, or this process can be automated where the content team 10 scans and identifies videos embedded in an electronic publication content 17 and updates the electronic publication's header or metadata information. Once the document has been optimized with respect to the video content it is published 20 and can be then executed by a user's device 130.

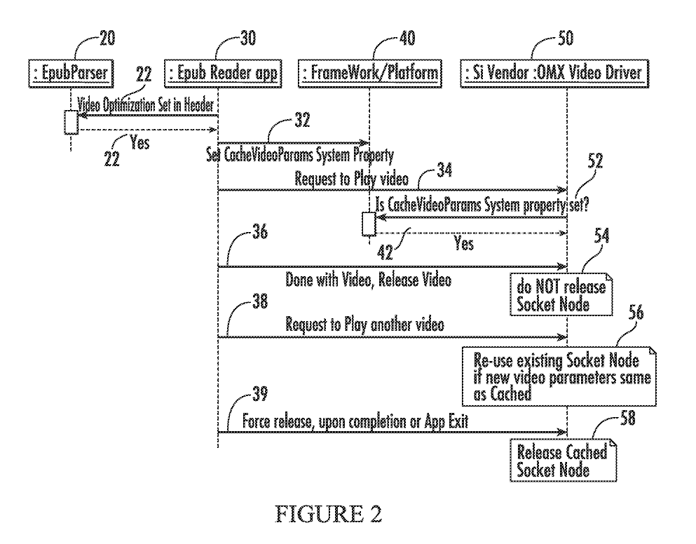

FIG. 2 illustrates a process in accordance with the present invention for executing and viewing an electronic publication that contains video content.

When an electronic publication, ePub, that contains video is loaded on a device 130, an ePub parser 20 parses the digital publication, for example the metadata in the document, to determine its content, particularly to determine if the publication contains video content. As described above, in a preferred embodiment, the metadata in the document contains a flag that indicates that video optimization has been performed on the document. The main reader application 30 in the device 130 reads 22 the flag value, and preferably the video coding parameters as well, if available. If the flag is set 24, the device 130 sets 32 a system property in the Framework Platform 40 that can be read by the video driver 50, OMX, when it is about to load a DSP socket node.

As the reader application 30 is executing the electronic publication, when it encounters video content, it sends 34 a request to the video driver 50 to execute the video. The video player 50 inquires 52 as to whether the flag for optimization has been set. If the system property is set 42, the video parameters are cached and the socket node established by the video player 50 is kept in memory in accordance with the optimization process of the present invention. Once the video is complete, any call 36 by the reader application 30 to release the socket node is ignored and the socket node is kept 54 in memory. As the reader application 30 continues to execute the electronic publication, subsequent calls 38 to play further video content re-use 56 this same socket node.

Once the execution of the electronic publication is finished, i.e. the reader application 30 in the device 130 no longer has focus, the reader application 30 or the framework 40 on its behalf, explicitly instructs 39 the video driver 50 to unload DSP socket node. This can be done 58 through a new MediaPlayer API, e.g. ReleaseForce( ), as follows:

```
OnPause( ) or OnDestroy( )
{
  Unset the CacheVideoParams system property
  Call MediaPlayer.ReleaseForce( ) //This ensures Socket node is
released , now that Video Epub does not have focus. We don't want
this feature for the regular Gallery
}
```

The above described embodiment is one in which the publishers/authors 15 and the content team 10 are able to use the same video parameters for every video contained in the electronic publication (see FIG. 1). If it is not possible to get all of the separate video content in an electronic publication to have the same coding parameters, the present invention can still experience some, if not most of the benefits of the approach described above, due to the fact that most videos are coded in a similar fashion. As described above, when the video driver realizes that it has to load a newsocket node in response to a video playback request of a different type than the one that is cached, the driver first unloads, releases, the socket node. The driver then loads a new socket node. This process adds at least an additional 100 ins to the setup time for pages in the electronic publication where the video type changes from previous pages.

However, the present invention, through offline analysis of the electronic publication creates a page and video type map and embeds it in the electronic publication header and metadata. In an exemplary embodiment of the present invention, the page and video map looks as follows:

TABLE 1

| Page Number | Video Type |
|---|---|
| 1 | 1 |
| 3 | 2 |
| 4 | 2 |
| 6 | 2 |
| 7 | 1 |

In Table 1 above, pages with the same video type indicate that they have video content coded with the same parameters. The present invention uses the information in this page map to set/unset the cached video parameters depending upon the page being viewed on the device. In the example indicated in Table 1, the metadata indicates the videos associated with pages 1 and 2 are of different types, i.e., different coding. Therefore, when the video on page 1 is completed, the device knows ahead of time that the socket node for the video on page 1 must be released, unloaded from memory, because the next video on page 2 is of a different type. However, since the next three videos, on pages 3, 4 and 6 are of the same type, the same socket node can be reused. Accordingly, the video driver will ignore, or the reader application will not issue any calls to release the node after playing the video on pages 3 and 4. After completion of the video on page 6, the video driver releases the node, as the system knows that the next video on page 7 will require a new node for the different coding of the video contained on that page.

As appreciated by those skilled in the art, avoiding the release and set-up that would otherwise be associated with the videos contained on pages 3, 4 and 6 saves a significant amount of time during the execution of the electronic publication.

A further example is illustrated below in Table 2. In the example illustrated in this

Table 2, page 2 has a video with different coding parameters than its neighboring pages 1 and 3. In this case, the present invention caches video parameters for only page 4 and 5, because going backward or forward from those pages, the system is guaranteed to re-use the same DSP decoder socket node.

The embodiments described above are applicable to electronic publications in which the video is embedded as part of the electronic publication. However, videos do not necessarily have to be embedded in the electronic publication file itself, but rather, the file can contain a link to the video, which is stored on a remote server. This type of linking structure may be preferable in order to keep down the size of the electronic publication files whose content includes video.

If this approach is adopted without the present invention , the video setup time will dramatically increase, since the video content is not locally stored and its parameters cannot be determined until after it has been retrieved from the remote server.

However, the present invention can solve this problem by applying variations of techniques in described above. These variations include the following: a. use the page-video map as described above to pre-download videos just in time, when the user is approaching a page with that video; and/or maintain a low quality version of the video embedded with the electronic publication locally and when the user starts playing the video, download the high quality version and switch dynamically. Either of these approaches will allow the system to determine the type of videos that are to be played and thus their coding characteristics. A system using the techniques of the present invention will be able to identify adjacent videos that share the same video characteristics and thus be able to maintain the socket nodes in memory and reduce the setup and release times associated with these videos.

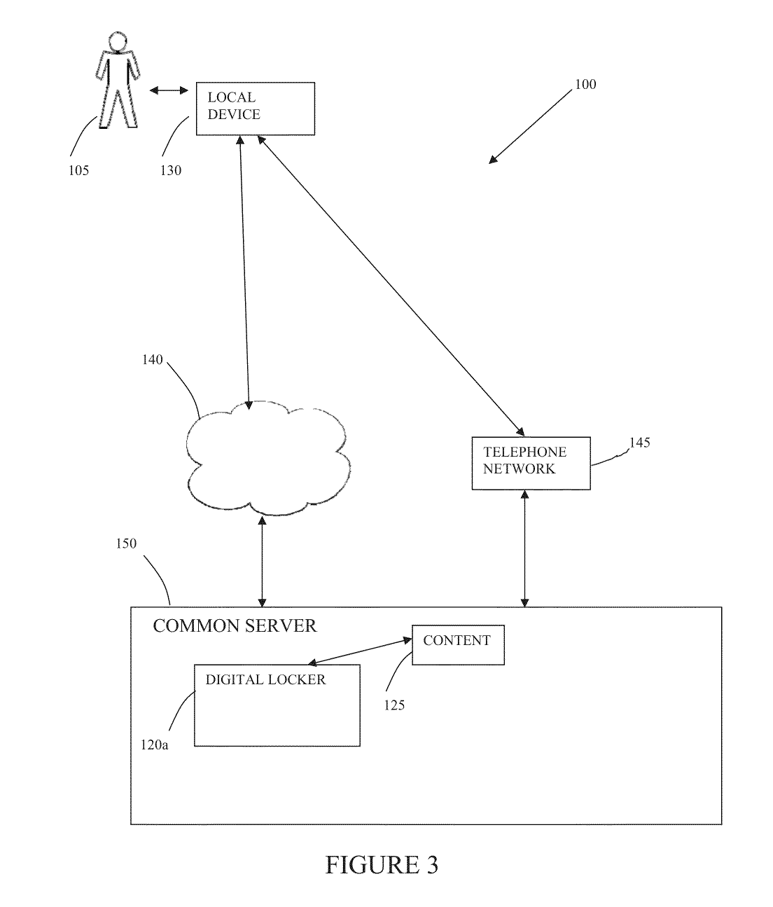

FIG. 3 shows components of a system according to the present invention. User 105 is an authorized user of system 100 and uses her local device 130 for the reading of digital content. Some of the functions of system 100 of the present invention are carried out on server 150. As appreciated by those skilled in the art, many of the functions described herein can be divided between the server 150 and the user's local device 130. Further, as also appreciated by those skilled in the art, server 150 can be considered a “cloud” with respect to the user and her local device 130. The cloud can actually be comprised of several servers performing interconnected and distributed functions. For the sake of simplicity in the present discussion, only a single server 150 will be described. The user 105 can connect to the server 150 via the Internet 140, a telephone network 145 (e.g., wirelessly through a cellphone network) or other suitable electronic communication means. User 105 has an account on server 150, which authorizes user 105 to use system 100.

Associated with the user's 105 account is the user's 105 digital locker 120 located on the server 150. As further described below, in the preferred embodiment of the present invention, digital locker 120 contains links to copies of digital content 125 previously purchased for otherwise legally acquired) by user 1105.

Indicia of rights to all copies of digital content 125 owned by user 105, including digital content 125, is stored by reference in digital locker 120. Digital locker 120 is a remote online repository that is uniquely associated with the user's 105 account. As appreciated by those skilled in the art, the actual copies of the digital content 125 are not necessarily stored in the user's locker 120, but rather the locker 120 stores an indication of the rights of the user to the particular content 125 and a link or other reference to the actual digital content 125. Typically, the actual copy of the digital content 125 is stored in another mass storage (not shown). The digital lockers 120 of all of the users 105 that have purchased a copy of a particular digital content 125 can point to this copy in mass storage. Of course, back up copies of all digital content 125 are maintained for disaster recovery purposes. Although only one example of digital content 125 is illustrated in this Figure, it is appreciated that the server 150 can contain millions of files 125 containing digital content. It is also contemplated that the server 150 can actually be comprised of several servers with access to a plurality of storage devices containing digital content 125. As further appreciated by those skilled in the art, in conventional licensing programs, the user does not own the actual copy of the digital content, but has a license to use it. Hereinafter, if reference is made to “owning” the digital content, it is understood what is meant is the license or right to use the content.

User 105 can access his or her digital locker 120 using a local device 130. Local device 130 is an electronic device such as a personal computer, an e-book reader, a smart phone or other electronic device that the user 105 can use to access the server 150. In a preferred embodiment, the local device has been previously associated, registered, with the user's 105 account using user's 105 account credentials. Local device 130 provides the capability for user 105 to download the user's copy of digital content 125 via his or her digital locker 120. After digital content 125 is downloaded to local device 130, user 105 can engage with the downloaded content locally, e.g., read the book, listen to the music or watch the video,

In accordance with one of the aspects of the present invention, video content referenced in a user's downloaded electronic publication 125 can be stored on sever 150. When approaching a page containing video, the user's device 130 can contact the server 150 and download the video as described above.

In a preferred embodiment, local device 130 includes a non-browser based device interface that allows user 105 to initiate functionality of system 100 in a non-browser environment. Through the device interface, the user 105 is automatically connected to the server 150 in a non-browser based environment. This connection to the server 150 is a secure interface and can be through the telephone network 145, typically a cellular network for mobile devices. If user 105 is accessing his or her digital locker 120 using the Internet 140, local device 130 also includes a web account interface. Web account interface provides user 105 with browser-based access to his or her account and digital locker 120 over the Internet 140.

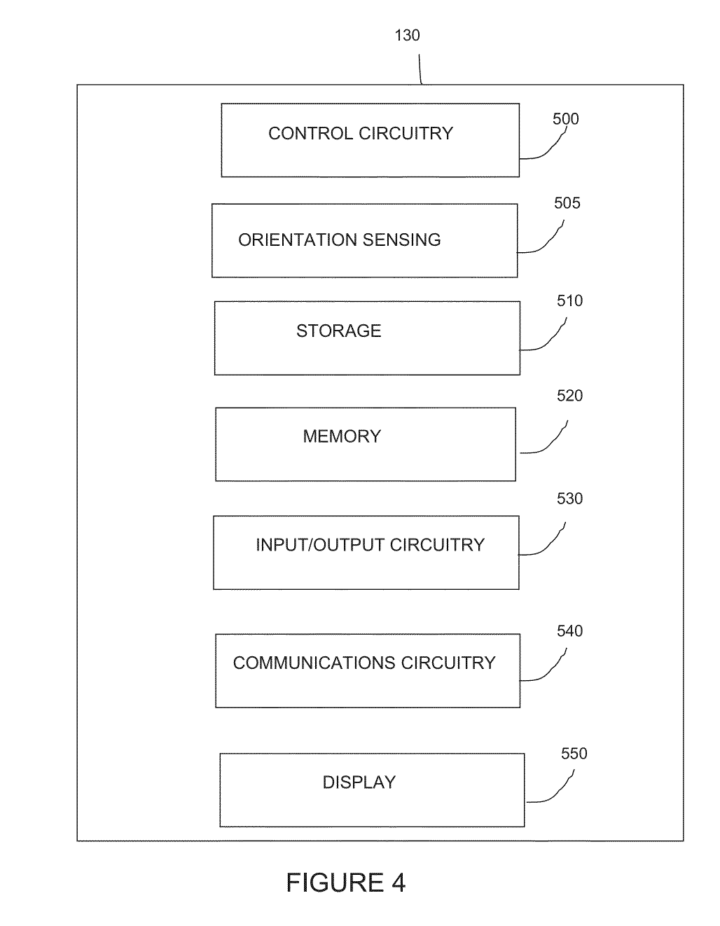

FIG. 4 illustrates an exemplary local device 130. As appreciated by those skilled the art, the local device 130 can take many forms capable of operating the present invention. As previously described, in a preferred embodiment the local device 130 is a mobile electronic device, and in an even more preferred. embodiment device 130 is an electronic reader device. Electronic device 130 can include control circuitry 500, storage 510, memory 520, input/output (“I/O”) circuitry 530, communications circuitry 540, and display 550. In some embodiments, one or more of the components of electronic device 130 can be combined or omitted, e.g., storage 510 and memory 520 may be combined. As appreciated by those skilled in the art, electronic device 130 can include other components not combined or included in those shown in FIG. 4, e.g., a power supply such as a battery, an input mechanism, etc.

Electronic device 130 can include any suitable type of electronic device. For example, electronic device 130 can include a portable electronic device that the user may hold in his or her hand, such as a digital media. player, a personal e-mail device, a personal data assistant (“PDA”), a cellular telephone, a handheld gaming device, a tablet device or an eBook reader. As another example, electronic device 130 can include a larger portable electronic device, such as a laptop computer. As yet another example, electronic device 130 can include a substantially fixed electronic device, such as a desktop computer.

Control circuitry 500 can include any processing circuitry or processor operative to control the operations and performance of electronic device 130. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Orientation sensing component 505 include orientation hardware such as, but not limited to, an accelerometer or a gyroscopic device and the software operable to communicate the sensed orientation to the control circuitry 500. The orientation sensing component 505 is coupled to control circuitry 500 that controls the various input and output to and from the other various components. The orientation sensing component 505 is configured to sense the current orientation of the portable mobile device 130 as a whole. The orientation data is then fed to the control circuitry 500 which control an orientation sensing application. The orientation sensing application controls the graphical user interface (GUI), which drives the display 550 to present the GUI for the desired mode.

Storage 510 can include, for example, one or more computer readable storage mediums including a hard-drive, solid state drive, flash memory, permanent memory such as ROM, magnetic, optical, semiconductor, paper, or any other suitable type of storage component, or any combination thereof Storage 510 can store, for example, media content, e.g., eBooks, music and video files, application data, e.g., software for implementing functions on electronic device 130, firmware, user preference information data, e.g., content preferences, authentication information, e.g., libraries of data associated with authorized users, transaction information data, e.g., information such as credit card information, wireless connection information data, e.g., information that can enable electronic device 130 to establish a wireless connection, subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 510.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 130. Although I/O circuitry 530 is illustrated in FIG. 4 as a single component of electronic device 130, several instances of I/O circuitry 530 can be included in electronic device 130.

Electronic device 130 can include any suitable interface or component for allowing a user to provide inputs to I/O circuitry 530. For example, electronic device 130 can include any suitable input mechanism, such as a button, keypad, dial, a click wheel, or a touch screen, e.g., display 550. In some embodiments, electronic device 130 can include a capacitive sensing mechanism, or a multi-touch capacitive sensing mechanism.

In some embodiments, electronic device 130 can include specialized output circuitry associated with output devices such as, for example, one or more audio outputs. The audio output can include one or more speakers, e.g., mono or stereo speakers, built into electronic device 130, or an audio component that is remotely coupled to electronic device 130, e.g., a headset, headphones or earbuds that can be coupled to device 130 with a wire or wirelessly.

Display 550 includes the display and display circuitry for providing a display visible to the user. For example, the display circuitry can include a screen, e.g., an LCD screen, that is incorporated in electronic device 130. In some embodiments, the display circuitry can include a coder/decoder (Codec) to convert digital media data into analog signals. For example, the display circuitry or other appropriate circuitry within electronic device 130 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 130, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications networks and to transmit communications, e.g., data from electronic device 130 to other devices within the communications network. Communications circuitry 540 can be operative to interface with the communications network using any suitable communications protocol such as, for example, WiFi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 130 can include one more instances of communications circuitry 540 for simultaneously performing several communications operations using different communications networks, although only one is shown in FIG. 4 to avoid overcomplicating the drawing. For example, electronic device 130 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 130 can be coupled to a host device such as digital content control server 150 for data transfers, synching the communications device, software or firmware updates, providing performance information to a remote source, e.g., providing riding characteristics to a remote server, or performing any other suitable operation that can require electronic device 130 to be coupled to a host device. Several electronic devices 130 can be coupled to a single host device using the host device as a server. Alternatively or additionally, electronic device 130 can be coupled to several host devices, e.g., for each of the plurality of the host devices to serve as a backup for data stored in electronic device 130.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A method for executing videos in an electronic publication, the method comprising:
receiving a request to execute a first video in the electronic publication;
determining characteristics of the first video;
establishing a video decoder socket in memory, the video decoder socket corresponding to the determined characteristics of the first video;
executing the first video using the video decoder socket in memory;
completing the execution of the first video;
determining characteristics of a second video contained in the electronic publication, the second video being logically adjacent the first video; and
maintaining the video decoder socket in memory if the characteristics of the second video are the same as the characteristics of the first video.

2. The method of claim 1, wherein the acts of determining the characteristics of the first and second video further comprise:
reading a flag, the flag indicating that all of the videos in the electronic publication have the same characteristics.

3. The method of claim 2, further comprising:
parsing the electronic document for an indication that all of the videos in the electronic publication have the same characteristics; and
setting the flag in a system property section of a framework platform.

4. The method of claim 3, further comprising:
a video driver receiving a request to execute the video from a reader application, the video driver reading the flag in response to the receipt of the request.

5. The method of claim 4, further comprising:
the video driver ignoring requests by the reader application to release the video decoder socket in memory if the flag indicates that all of the videos in the electronic publication have the same characteristics.

6. The method of claim 1, wherein the acts of determining the characteristics of the first and second video further comprise:
reading a table contained in the electronic document, the table identifying the videos in the electronic document and their respective characteristics.

7. The method of claim 1, wherein the video decoder socket is a first video decoder socket, the method further comprising;
if the characteristics of the second video are different from the characteristics of the first video:
releasing the first video decoder socket, and
establishing a second video decoder socket in memory, the second video decoder socket corresponding to the determined characteristics of the second video.

8. The method of claim 1, wherein the first and second videos are contained in the electronic publication by reference to external locations where the videos are stored, wherein the acts of determining the characteristics of the first and second video further comprise:
downloading he videos from the external locations prior to their execution; and
examining the videos to determine their characteristics.

9. The method of claim 1, wherein the characteristics of the first and second videos includes a video codec used to encode the video, an encoded resolution, and an the encoded bit rate.

10. A system for executing videos in an electronic publication comprising:
a memory that includes instructions for operating the system, and includes the electronic publication;
a display; and
control circuitry coupled to the memory and coupled to the display, the control circuitry capable of executing the instructions and is operable to at least:
execute the instructions necessary to display the electronic publication on the display;
identify a first video in the electronic publication for execution;
determining characteristics of the first video;
identify a second video in the electronic publication for execution, the second video being logically adjacent the first video;
determine characteristics of the second video;
establish a video decoder socket in memory, the video decoder socket corresponding to the determined characteristics of the first video;
execute the first video using the video decoder socket in memory in order to display the first video on the display;
complete the execution of the first video; and
maintain the video decoder socket in memory if the characteristics of the second video are the same as the characteristics of the first video.

11. The system of claim 10, wherein the control circuitry is further operable to execute the instructions to the performing acts of determining the characteristics of the first and second video by;
reading a flag, the flag indicating that all of the videos in the electronic publication have the same characteristics.

12. The system of claim 10, wherein the control circuitry is further operable to execute the instructions to:
parse the electronic document for an indication that all of the videos in the electronic publication have the same characteristics; and
set the flag in a system property section of a framework platform.

13. The system of claim 12, further comprising:
a video driver, wherein the video driver receives a request to execute the video from a reader application being executed by the control circuitry, the video driver reading the flag in response to the receipt of the request

14. The system of claim 13, wherein the video driver ignores requests by the reader application to release the video decoder socket in memory if the flag indicates that all of the videos in the electronic publication have the same characteristics.

15. The system of claim 10, wherein the control circuitry is further operable to execute the instructions to the performing acts of determining the characteristics of the first and second video by:
reading a table contained in the electronic document, the table identifying the videos in the electronic document and their respective characteristics.

16. The system of claim 10, wherein the control circuitry is further operable to execute the instructions to:
if the characteristics of the second video are different from the characteristics of the first video:
release the first video decoder socket, and
establish a second video decoder socket in memory, the second video decoder socket corresponding to the determined characteristics of the second video.

17. The system of claim 10, wherein the first and second videos are contained in the electronic publication by reference to external locations where the videos are stored and wherein the control circuitry is further operable to execute the instructions to the performing acts of determining the characteristics of the first and second video by:
downloading the videos from the external locations prior to their execution; and
examining the videos to determine their characteristics.

18. The system of claim 10, wherein the characteristics of the first and second videos includes a video codec used to encode the video, an encoded resolution, and an the encoded bit rate.

19. A non-transitory computer-readable medium comprising a plurality of instructions that, when executed by a computer system, at least cause the computer system to:
execute the instructions necessary to display an electronic publication on a. display;
identify a first video in the electronic publication for execution;
determining characteristics of the first video;
identify a second video in the electronic publication for execution, the second video being logically adjacent the first video;
determine characteristics of the second video;
establish a video decoder socket in memory, the video decoder socket corresponding to the determined characteristics of the first video;
execute the first video using the video decoder socket in memory in order to display the first video on the display;
complete the execution of the first video; and
maintain the video decoder socket in memory if the characteristics of the second video are the same as the characteristics of the first video.

20. The non-transitory computer-readable medium of claim 19, wherein the instructions further cause the computer system to:
read a flag, the flag indicating that all of the videos in the electronic publication have the same characteristics,

21. The non-transitory computer-readable medium of claim 19, wherein the instructions further cause the computer system to:
read a table contained in the electronic document, the table identifying the videos in the electronic document and their respective characteristics.
